(19) United States
(12) Patent Application Publication
(10) Pub. No.: US 2011/0079731 A1
(43) Pub. Date: Apr. 7, 2011

(54) MULTIPOLE LENS FOR ELECTRON COLUMN

(76) Inventor: Ho Seob Kim, Incheon (KR)

(21) Appl. No.: 12/994,944

(22) PCT Filed: May 27, 2009
(86) PCT No.: PCT/KR2009/002801

§ 371 Date: Nov. 29, 2010

(30) Foreign Application Priority Data
May 27, 2008 (KR) 10-2008-0049010

(51) Int. Cl. H01J 3/18

(52) U.S. Cl. 250/396 R

(57) ABSTRACT

The present invention relates to an electron lens for use in an microcolumn, and more particularly to a multipole electron lens wherein the electron lens includes two or more electrode layers, each of the electrode layers has a slit aperture extending across a central optical axis along which an electron beam passes, and the two electrode layers are aligned on an electron optical axis such that the slit apertures are staggered with each other. Further, the present invention relates to a microcolumn using the multipole lens. The multipole lens according to the present invention can be manufactured and controlled in a simple fashion, reduces the defocusing of the microcolumn, and increases an active deflection area.

### TECHNICAL FIELD

The present invention relates to an electron lens, and more particularly to a multipole electron lens which is used to minimize the distortion of an electron beam caused by aberration in the electron optical point of view of an electron lens that controls an electron beam, in an electron column, such as a microcolumn.

### BACKGROUND ART

An electron column includes an electron emission source and electron lenses, creates and scans an electron beam, and is used in electron microscopes, semiconductor lithography, or inspection devices that use an electron beam, such as devices for inspecting the via/contact holes of semiconductor devices, devices for inspecting and analyzing the surfaces of samples, or devices for inspecting the Thin Film Transistors (TFTs) of TFT-LCD devices.

A representative of such an electron column is a microcolumn. A microcolumn based on an electron emission source and electron optical parts having minute structures, which operates according to the basic principle of a Scanning Tunneling Microscope (STM), was first introduced in the 1980s. A microcolumn enables optical aberration to be minimized by allowing minute parts to be elaborately assembled, thus forming an improved electron column. A plurality of small structures is arranged, and can be then used in a multi-type electron column structure having a parallel or series structure.

FIG. 1 is a diagram showing the structure of a microcolumn, and indicates that an electron emission source, a source lens, a deflector and an Einzel lens are aligned and scan an electron beam.

In general, a microcolumn, that is, a representative very small-sized column, includes an electron emission source 10 configured to emit electrons, a source lens 20 configured to include three electrode layers to emit, accelerate and control an electron beam and to convert the emitted electrons into an effective electron beam B, a deflector 30 for deflecting the electron beam, and a focusing lens (Einzel lens) 40 configured to focus the electron beam into a sample S. Generally, the deflector is located between the source lens and the Einzel lens.

In order to operate the microcolumn in a general manner, negative voltage in a range of about −100˜about −2 kV is applied to the electron emission source, and the electrode layers of the source lens are commonly grounded.

The Einzel lens, that is, an example of a focusing lens, focuses an electron beam (is used to focus an electron beam) in such a way that external electrode layers on both sides thereof are grounded and negative (−) voltage (deceleration mode) or positive (+) voltage (acceleration mode) is applied to a central electrode layer.

At the same operating distance, the magnitude of focusing voltage in deceleration mode is less than that in acceleration mode. Synchronized deflecting voltage is applied to adjust the path of an electron beam and then scan the electron beam onto a sample surface in regular periods. The electron lens, such as the above-described source lens or focusing lens, includes two or more electrode layers each including an aperture having a circular or predetermined shape at the central thereof to allow an electron beam to pass therethrough, and controls the electron beam. It is generally formed of three electrode layers.

The electron emission source, that is, one of the core components of the conventional electron column, is a source for emitting electrons, and a Field Emission Emitter (FEE), a Thermal Emitter (TE) for use as a thermion emission source, or a Thermal Field Emitter (TFE) is used as the electron emission source. The electron emission source requires stable electron emission, high current, small size, low energy spread, and a long life span.

Electron columns are classified into single electron columns each including a single electron emission source and electron lenses for controlling an electron beam generated by the electron emission source, and multi-type electron columns each including electron lenses for controlling a plurality of electron beams emitted by a plurality of electron emission sources. The multi-type electron columns may be classified into wafer-type electron columns, each including an electron emission source configured such that a plurality of electron emission source tips is provided in a single layer, such as a semiconductor wafer, and an electron lens configured such that lens layers in which a plurality of apertures are formed in a single layer are stacked on each other, combination-type electron columns each configured to control electron beams, emitted by respective electron emission sources like a single electron column, using a lens layer having a plurality of apertures, and array-type columns each configured such that single electron columns are mounted and used in a single housing. In the case of a combination-type column, electron emission sources are separate, but lenses are used in the same manner as those of the wafer-type column.

With regard to the performance of an electron column, an electron lens has electron optical aberration problems like a typical optical lens, so that problems, such as a beam distortion phenomenon or a defocusing phenomenon, occur in the electron lens of the electron column due to aberrations, such as spherical aberration, stigmatism and coma from an electron optical point of view. Furthermore, the shape of an aperture is not completely symmetrical or the alignment of apertures with each other is not achieved due to machinery precision problems that arise during a manufacturing process and even the contamination of an electrode influences field strength, so that it is impossible to manufacture an electron lens which can produce an electric field whose electric field strength is completely symmetrical. Accordingly, astigmatism generally occurs even if the aperture is circular. In order to mitigate these problems, an octupole lens was proposed and become conventional technology. Furthermore, in an electron column, the electron beam must be deflected and then scan a sample. Accordingly, when an electron beam deviates from the central optical axis of a focusing lens because of deflection and then passes through the focusing lens, the electron beam is distorted. The phenomenon of the expansion of an electron beam resulting from astigmatism and the phenomenon of the distortion of an electron beam have a negative influence on the resolution of an electron column.

Furthermore, the conventional octupole lens and other multipole lenses have the problems of being difficult to manufacture, control and align because a plurality of electrodes is distributed across a single lens layer.

### DISCLOSURE

### Technical Problem

An object of the present invention is to provide a multipole lens, which is easy to manufacture and operates using a simple operating method, in a lens for focusing an electron beam in order to improve a resolution reduction phenomenon which occurs in an electron column due to astigmatism.

Another object of the present invention is to separately provide means for adjusting the alignment of an electron beam and means for deflecting the electron beam in the above-described improved electron lens structure in order to improve an electron beam distortion phenomenon resulting from aberrations in a focusing lens.

### Technical Solution

In order to accomplish the above objects, the present invention provides a focusing lens structure having electrodes at various angles around the electron optical axis of an electron column.

Furthermore, the present invention provides a structure in which in a focusing lens structure including four electrode layers, two outside electrode layers include typical apertures and two inside electrode layers include vertically longitudinal apertures or laterally longitudinal apertures.

Furthermore, in order to accomplish the above objects, the present invention provides a multipole electron lens, including two or more electrode layers, wherein each of the electrode layers has a slit type aperture extending across a central optical axis along which an electron beam passes, and the electrode layers are arranged along an electron optical axis such that the slits are located in different directions.

Furthermore, the present invention provides an electron column in which a focusing lens includes the multipole lens.

The vertically longitudinal slit (aperture) and the laterally longitudinal slit (aperture) preferably proposed in the present invention are configured in a structure in which they are opposite each other. An electron lens including electrode layers having slit apertures as described above is referred to as a multipole lens.

Furthermore, the present invention provides an electron column including an electron emission source, an electron lens and a deflector, wherein the focusing lens includes a multipole lens.

In the conventional electron column such as that shown in FIG. 1, when an electron beam is focused on and scanned across a sample, defocusing and the distortion of an electron beam spot occurs ordinarily. In particular, when an electron beam is scanned by the deflector, the electron beam deviates from the central optical axis of the focusing lens, so that the shape of the spot formed by the electron beam is distorted.

The above-described phenomena of the expansion and distortion of the electron beam spot result from astigmatism occurring in the source lens and the focusing lens and spherical and comma aberration occurring in the focusing lens.

Accordingly, the present invention provides the electrode structure of an electron lens in order to reduce the expansion of the size and distortion of the shape of an electron beam spot.

An electron column in which the expansion and the distortion of the electron beam spot resulting from the deviation from the central optical axis of the electron beam are reduced by using the multipole lens of the present invention as the internal central electrode layer of a focusing lens (for example, an Einzel lens) and appropriately disposing the focusing lens using the multipole lens between an aligner and a deflector can be manufactured.

The above-described multipole lens, in the case of an Einzel lens, that is, a focusing lens in the present invention, may be used in replacement of a central electrode layer which is one of three electrode layers and is not grounded and to which voltage is separately applied, and, in the case of a source lens, may be used in a central electrode layer which is not grounded. Although the entire source lens may be grounded and then used, a source lens including three electrode layers may function to focus an electron beam by applying voltage to a central electrode layer, in which case the multipole lens may be applied to the central electrode layer. In the case of the above-described focusing lens, it is preferred that a quadrupole lens in which two lens layers are symmetrically arranged in a perpendicular direction be used as the multipole lens.

The reason for this is that a total of four lens layers are preferably used when it is used in the conventional Einzel lens. The detailed reason will be described below.

The Einzel lens including the multipole lens electrodes and the electron column including the source lens according to the present invention may be designed in various arrangements, and the multipole lens electrodes of the present invention may not be included in the Einzel lens or the source lens but may be used as separate independent electrodes.

### ADVANTAGEOUS EFFECTS

The multipole lens according to the present invention is advantageous in that each electrode layer can be easily manufactured using a method in which a slit aperture or an elliptically or similarly shaped aperture is provided, like in an electrode layer of a lens having conventional a circularly or similarly shaped aperture.

The electron column using the multipole lens according to the present invention can improve the resolution of the electron column because it can create a small, uniform electron beam spot.

Furthermore, the electron column using the multipole lens, the aligner and the deflector according to the present invention can improve an actual active scan area because it can reduce the deflection defocusing of an electron beam spot caused by various types of distortion which occur in an area around a sample.

Furthermore, the multipole lens according to the present invention facilitates the control of the lens because the number of electrodes to be controlled is reduced compared with the conventional electron lens when it is used in the electron lens which performs focusing functionality.

Moreover, the multipole lens according to the present invention has the advantage of facilitating the manufacture of a multi-type microcolumn because it can be easily manufactured in a wafer form like the conventional electron lens electrode layer, and has the advantage of facilitating the control of the lens because the number of electrodes to be controlled is small.

### DESCRIPTION OF DRAWINGS

FIG. 1 is a sectional view showing the structure of a conventional microcolumn;

FIG. 2 is a perspective view showing an example of a multipole lens according to the present invention;

FIG. 3 is a perspective view showing another example of the multipole lens according to the present invention;

FIG. 4 is a perspective view showing still another example of the multipole lens according to the present invention; and

FIG. 5 is a sectional view showing the structure of a microcolumn using a quadrupole lens according to the present invention.

### MODE FOR INVENTION

The present invention is provided to form a low-aberration, low-distortion, high-resolution electron beam spot by using a multipole lens in an electron column.

The present invention provides an electrostatic multipole lens which is capable of correcting not only astigmatism but also the deformation of the shape of a beam spot for the entire deflection field so as to improve the performance of an electron column.

The electrostatic multipole lens of the present invention has a simple structure, and reduces the deflection defocusing of an electron beam spot, resulting from various types of distortion generated around a sample by an electron beam scanned by an electron column, by using the multipole lens in the focusing lens.

As an example of such a multipole lens having a simple structure, perpendicular apertures are schematically illustrated in FIG. 2.

In FIG. 2, each quadrupole lens 400, that is, a multipole lens for electron optical design, is configured to include two opposite electrode layers 400a and 400b which are perpendicular to the z axis indicated by an arrow. One or both of them may include a non-circular aperture. Furthermore, different electric potentials are applied to opposite electrode layers 400a and 400b. With regard to the structure shown in FIG. 2, for example, in FIG. 2(a), the vertical slot 430 of the first electrode layer 400a is aligned with the lateral slot 440 of the second electrode layer 400b, while in FIG. 2(b), the lateral slot 440 of the second electrode layer is aligned with the vertical slot 430 of a first electrode. In the quadrupole lens 400, the first electrode layer 400a and the second electrode layer 400b are distinguished from each other in that the first electrode layer 400a has the vertical slot 430 and the second electrode layer 400b has the lateral slot 440, for convenience's sake. Although in the drawing, the appearances of the electrode layers 400a and 400b are illustrated as being rectangular, they may have square or circular shapes. An electric field generated in the region of the quadrupole lens influences an electron beam passing through the slots 430 and 440 in the same way as does an electric field generated by a stigmator having four or eight electrodes, but the quadrupole lens does not require a plurality of electrodes to be controlled unlike a typical stigmator in which a single electrode layer is divided into a plurality of electrodes.

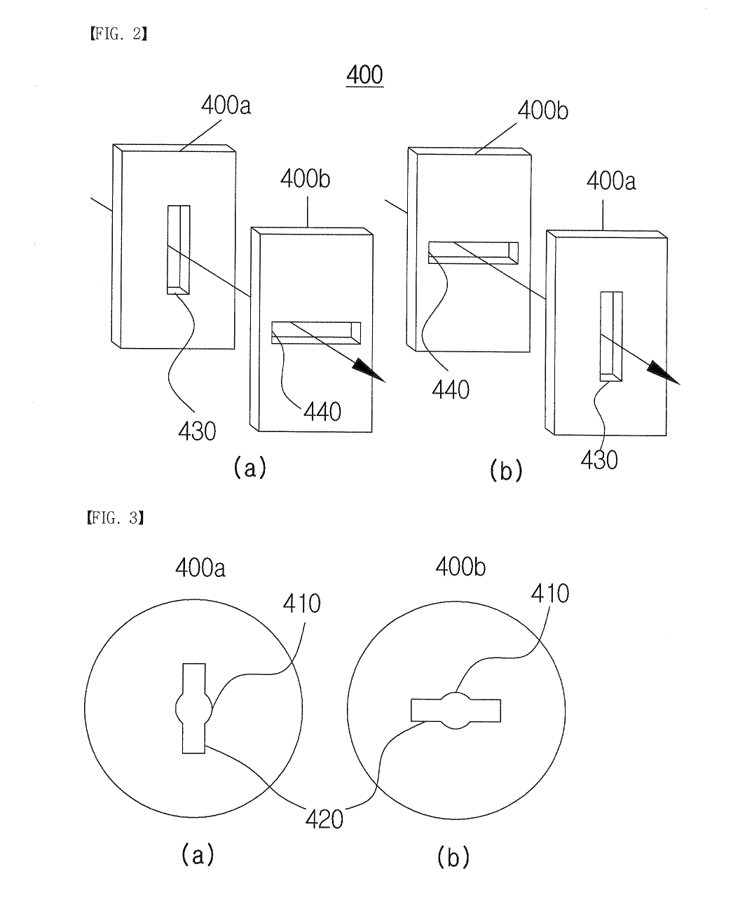

As another example of the quadrupole lens, a quadrupole lens having a so-called keyhole-shaped aperture is preferably provided such that it can be used in a microcolumn. A plan view of a lens electrode layer having a keyhole-shaped aperture given in FIG. 3 is illustrated as an example. The keyhole-shaped aperture includes a circular aperture 410 and a rectangular slit aperture 420. The rectangular slit aperture 420 is characterized in that the width thereof is less than the diameter of the circular aperture 410.

The circular aperture 410 is an aperture which is used in a conventional electron lens, and the keyhole-shaped aperture is formed by overlapping the circular aperture and the rectangular aperture 420. Since the width of the rectangular aperture 420 is less than the diameter of the circular aperture 410, a keyhole shape is formed on the whole. That is, the rectangular aperture 420 corresponds to one of the slits 430 and 440 shown in FIG. 2, and is added to a circular aperture. Here, the purpose of applying the circular aperture is to precisely align with the existing circular aperture. It is preferred that the width of the slit be less than the diameter of the aperture so as to allow the effect of the quadrupole lens to be efficiently achieved. Since the effect of the multipole lens varies depending on the ratio with respect to the length to the width of the slit, it is preferred that the optimal width and length be selected based on design data, such as the performance of the source lens or the distance to a sample.

Furthermore, although the circular aperture is illustrated as an example in FIG. 3 and a circular lens aperture is commonly used, a slit may also be used in the same overlapping manner as described above in the case where an aperture having a special shape, such as that for a shape beam, is used.

Furthermore, the electrostatic quadrupole lens of the present invention to which predetermined electrode voltage is applied is a focusing lens, as shown in FIGS. 2 and 3, and may be used as part of an Einzel lens. Furthermore, if the lens electrode layers are square, although in FIG. 2, the lens electrode layers are illustrated as being rectangular, the former lens electrode layers are manufactured like the circular lens electrode layers of FIG. 3, and then they are perpendicularly arranged and used on the basis of slits. Accordingly, this enables the manufacture of the lens electrode layer to be easily carried out.

The slit aperture of the quadrupole lens of the present invention may be manufactured in a membrane form like the aperture of the lens electrode layer of a microcolumn, in which case an advantage arises in that it can be manufactured using a manufacturing method identical to a method for manufacturing the electrode layer of a typical lens. Although the shape of the slit is illustrated as being longitudinally rectangular both in FIGS. 2 and 3, it may have a longitudinally elliptical or polygonal shape. The important thing is that the electrode layers of the quadrupole lens form different electric fields inside the slits in lateral and vertical directions using voltage applied to the electrode layers, thereby changing the shape of an electron beam passing through the centrals of the slits, like a stigmator.

One of the most preferable methods of using the quadrupole lens according to the present invention is to locate and use it inside a focusing lens (for example, an Einzel lens). The advantage of such an Einzel lens is that the structure of the quadrupole lens is very simple and is easy to assemble. The effect of the quadrupole lens is that the defocusing occurred on a sample surface due to astigmatism is corrected and therefore the performance of the electron column including the Einzel lens is improved. As a result, the focusing of an electron beam is further improved by applying quadrupole voltage. The above-described electron column using a quadrupole lens according to the present invention requires only one more additional application voltage.

The operation of the quadrupole lens according to the present invention will be described in comparison with the adjustment of the focusing voltage of the conventional Einzel lens.

In general, in a focusing lens (for example, an Einzel lens), the same voltage is applied to two outer electrodes, and a different voltage is applied to a central electrode. Commonly, focusing voltage is applied to the central electrode of the Einzel lens, and the other two electrodes are grounded. Diagram 1 is a diagram showing the adjustment of the voltage of the central electrode of a conventional focusing lens.

As shown in Diagram 1, the minimum beam spot sizes generated by lateral x-axis focusing and vertical y-axis focusing correspond to different voltages. The principal reason therefor is the stigmatism of the electron lens. Accordingly, the optimized focusing voltage shown in Diagram 1 is determined by considering the aspects of both the lateral and vertical focusing.

In Diagram 1, the x axis represents the focusing voltage, and the y axis represents the electron beam spot size. Although it is preferred that the size of the beam spot depending on the variation in the focusing voltage of the central electrode be located at the lowest points of the above curves, the most preferable focusing voltage value ‘a’ on the x axis and the most preferable focusing voltage value ‘b’ on the y axis are different. In Diagram 1, the focusing voltage value ‘a’ on the x axis is greater than the focusing voltage value ‘b’ on the y axis. Accordingly, with regard to the focusing voltage of the central electrode of the conventional focusing lens, a focusing voltage having a value which is represented as an intermediate value ‘c’ between the x-axis value and the y-axis value in Diagram 1 is applied.

In contrast, the quadrupole lens of the present invention is provided with the functionality of correcting astigmatism when different voltages are applied to two opposite electrodes, respectively, and the voltages of the application electrodes are shown in Diagram 2.

When the phenomenon of the expansion of an electron beam occurring due to the difference between the lateral focusing voltage and the vertical focusing voltage caused by astigmatism is reduced by applying quadrupole voltage, highly uniform resolution is achieved. Accordingly, the size of the electron beam spot can be reduced compared with the normal size, and the actual scan active region is increased. That is, as shown in Diagram 2, voltage Q2 indicating the x-axis focusing voltage of the quadrupole lens of the present invention and voltage Q1 indicating the y-axis focusing voltage are applied to the electrodes of the quadrupole lens, respectively. That is, unlike the voltage value ‘c’ applied to the conventional single central electrode, the voltage Q2 related to the x axis is applied to the electrode 400b of the quadrupole lens 400 and voltage Q1 related to the y axis is applied to the electrode 400a.

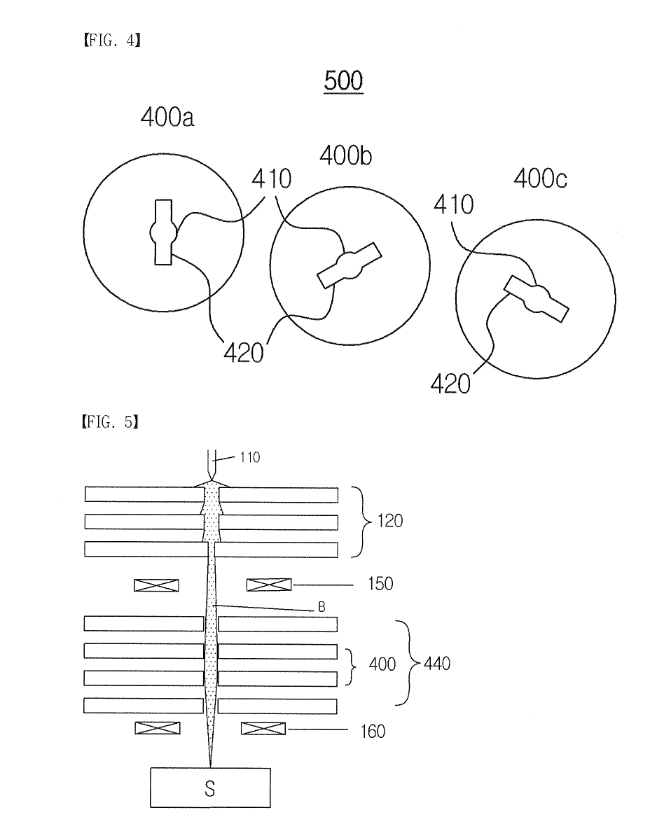

In the embodiments of FIGS. 2 and 3, the quadrupole lens has been described as a representative example of the multipole lens according to the present invention, FIG. 4 illustrates a multipole lens 500 using three electrode layers as another example of the multipole lens according to the present invention. This multipole lens 500 is formed by further adding a third electrode layer 400c unlike the quadrupole lens of FIG. 3, and individual electrode layers are arranged at angular intervals of 60 degrees. That is, unlike in the perpendicular arrangement of the quadrupole lens of FIG. 3, electrode layers are arranged at angular intervals of 60 degrees because one more electrode layer is added. Therefore, if an electrode layer is further added and, hence, four electrode layers are present, they may be arranged at angular intervals of 45 degrees.

Since a single electrode layer for a multipole lens according to the present invention has the number of electrodes equal to the two electrodes of a stigmator, the quadrupole lens requires two control voltages, and a sextupole lens including three electrode layers requires three control voltages. Whenever the number of electrode layers is increased by one, two electrodes are added. Since the direction of an electrostatic field applied to an electron beam varies depending on the electrode layer, the number of electrode layers and the interval angle of arrangement may be determined as necessary.

Furthermore, although for control purposes it is preferable that the interval angle of the electrode layers be an angle which allows the electrodes to be arranged symmetrically, symmetry is not necessarily required in case of need. That is, the third electrode layer is added to the quadrupole lens of FIG. 3 and used at a different angle, and may be configured and used according to the specific purpose. In a single electrode layer, a slit may be formed to have a bent angle, other than the illustrated rectilinear shape, on the basis of a central aperture. However, when the number of control electrodes or the thicknesses or design of lens layers are taken into account, a quadrupole lens including two electrode layers is the most convenient to use.

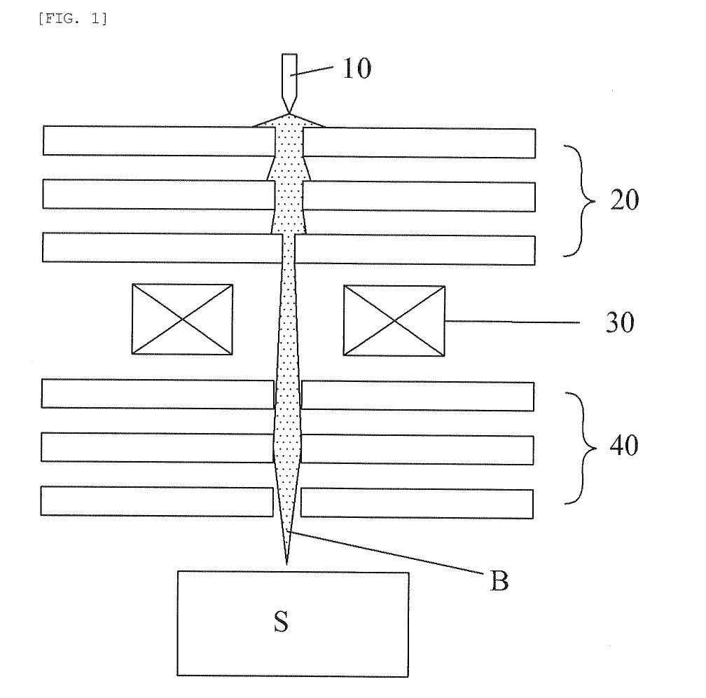

A new example of an electron column that uses the quadrupole lens to maximize the actual active deflection area, in addition to using the quadrupole lens, that is, a representative example of the multipole lens of the present invention, instead of the central electrode of the focusing lens 40 of the conventional electron column shown in FIG. 1, will now be described.

FIG. 5 is a sectional view showing the structure of a microcolumn using a quadrupole lens according to the present invention. The microcolumn includes an electron emission source 110, a source lens 120, an aligner 150, an Einzel lens 440, and a deflector 160. In comparison with the microcolumn of FIG. 1, the Einzel lens 440 used as a focusing lens includes and uses four electrode layers including a quadrupole lens 400. That is, the central electrode layer of the above-described Einzel lens 40 is replaced with the quadrupole lens 400 of the present invention. The microcolumn according to the present invention is different in that the aligner 150 is provided at the entrance to the Einzel lens 440 and the deflector 160 is provided at the exit therefrom.

In the conventional electron column such as that shown in FIG. 1, when the deflector deflects an electron beam, the deflected electron beam cannot pass along an electron optical axis in the focusing lens disposed below the deflector. Accordingly, the phenomenon of the expansion of the spot of the electron beam increases and expands outside of the deflection area. As a result, as shown in FIG. 5, in order to eliminate aberrations in the Einzel lens, the deflector is disposed below the Einzel lens, so that the actual active deflection area can be increased.

The multipole lens according to the present invention and the electron column using the multipole lens can create a small, uniform electron beam spot for use in a low-energy scanning microcolumn. The microcolumn system according to the present invention may be used as a multi-type microcolumn and the multipole lens of the present invention can be manufactured by a manufacturing process identical to that by which a typical electron lens is manufactured. As an example, a wafer-type electron lens (lens layers in which a plurality of apertures is formed are stacked on a large silicon substrate) is applied in an unchanged state, and therefore the present invention is especially advantageous for the manufacture of wafer- and multi-type microcolumns.

### INDUSTRIAL APPLICABILITY

The electron column using a multipole lens according to the present invention is used in electron microscopes, semiconductor lithography, or inspection devices that use an electron beam, such as devices for inspecting the via/contact holes of semiconductor devices, devices for inspecting and analyzing the surfaces of samples, or devices for inspecting the Thin Film Transistors (TFTs) of TFT-LCD devices.

1. A multipole electron lens, comprising:
two or more electrode layers,
wherein each of the electrode layers has a slit aperture extending across a central optical axis along which an electron beam passes, and the electrode layers are arranged along an electron optical axis such that the slit apertures are located in different directions.

2. The multipole electron lens as set forth in claim 1, wherein the multipole electron lens is an quadrupole electron lens in which the electrode layers are formed of two electrode layers, and wherein different voltages are applied to the electrode layers, respectively.

3. The multipole electron lens as set forth in claim 1 or 2, wherein each of the electrode layers has an additional aperture around a central optical axis along which the electron beam passes, and the slit aperture formed around the aperture is formed to be narrower and longer than the aperture.

4. The multipole electron lens as set forth in claim 3, wherein the additional aperture basically has a circular shape, and a shape including shapes of the slit aperture and the additional aperture is a keyhole shape.

5. The multipole electron lens as set forth in claim 3, wherein the additional aperture basically has a circular shape, and a shape including shapes of the slit aperture and the additional aperture is a polygonal hole shape.

6. The multipole electron lens as set forth in any one of claims 1 to 5, wherein the multipole electron lens replaces a central electrode layer which belongs to a focusing lens or a source lens having three or more electrode layers, or an electrode layer to which an individual voltage is applied and which is not grounded.

7. An electron column, comprising an electron emission source, one or more electron lenses, and a deflector, wherein one or more of the electron lenses comprise the multipole electron lens set forth in any one of claims 1 to 6.

8. The electron column as set forth in claim 7, wherein a focusing lens comprises the multipole lens set forth in claim 4 as the electron lenses, an aligner is provided in front of the focusing lens, and the deflector is disposed at a most downstream location on an electron optical axis along which an electron beam passes.

9. The electron column as set forth in claim 7, wherein the electron column is a multi-type microcolumn using a wafer-type electron lens, and the multipole lens is formed of a multi-type electrode layer in which the slit apertures or a plurality of slit apertures and additional apertures are formed in a large wafer.
